(19) United States
(12) Patent Application Publication
(10) Pub. No.: US 2015/0202109 A1
(43) Pub. Date: Jul. 23, 2015

(54) Penis Enlargement Device

(71) Applicants: Victor Levin, Highland Park, IL (US); Daniel Marc Levin, Highland Park, IL (US)

(72) Inventors: Victor Levin, Highland Park, IL (US); Daniel Marc Levin, Highland Park, IL (US)

(21) Appl. No.: 14/582,755

(22) Filed: Dec. 24, 2014

Related U.S. Application Data
(60) Provisional application No. 61/920,586, filed on Dec. 24, 2013.

(51) Int. Cl. A61H 1/00

(52) U.S. Cl. CPC A61H 1/008

(57) ABSTRACT

A system for penis enlargement that uses stackable weights inside enclosed plastic cylinder that slides into the device and contains the entire penis shaft of the user. The custom stackable weights create sufficient weight to collapse the neck of the device around the base of the penis, and achieved by securely connecting the flange of the device behind a custom waist strap with multiple adjustment straps to keep the device tightly pressed against user's body in groin region. This creates the oppositional forces required to facilitate the process of stretching of the inner ligaments and inner penis tissues while keeping the entire penis shaft contact and clamps free.

This application is related to, and claims priority from, United States Provisional Patent application number 61/920,586 filed Dec. 24, 2013. Application 61/920,586 is hereby incorporated by reference in its entirety.

### BACKGROUND

1. Field of the Invention:

The present invention relates generally to methods and devices for enhancing the penis of a male individual, and more particularly to a variable, non-mechanical and non-invasive penis enlargement device configured to provide permanent enlargement of the penis over a period of time.

2. Description of the Prior Art

Similar to any other feature of the human body, there are variations in the natural size, shape, and overall physiological characteristics of the penis between individuals. Ostensibly, the characteristics of most concern of many individuals, and one of frequent debate, is the size of their penis. Indeed, it is well known that in some cases, natural penis size can vary significantly, but it is said that most individuals in the population are of average size. Genetics play the primary role, in most cases, in determining natural penis size. However, there are those individuals that are victims of unfortunate circumstance, such as those that experience some type of abnormal growth that may be attributed to or a result of complications experienced during their development, resulting in a penis size that is, in some cases, much smaller than average. While most individuals are content with their natural size, there are others that desire to increase the size of their penis. As a result, there recently have been several methods, devices, and systems that have surfaced, designed and configured to enhance or enlarge the penis of an individual. Enlargement of the penis typically means increasing either the overall length of the penis, or increasing the girth or circumference of the penis, or both of these. The standard measurement for determining the length of the penis is typically from the pubis region to the tip of the penis, either during an erect or flaccid state.

There are two approaches known in the art to enlarge the penis. The first approach is a non-invasive approach that focuses on enlargement of the penis over time, or prolonged penis enlargement, wherein the individual utilizes, on a periodic basis, some type of system or device to carry out the goals of either lengthening the penis, or increasing the overall girth of the penis, or both. The second approach is an invasive approach, where the user elects to undergo one or more developed surgical procedures, such as to receive implants. Surgery typically requires a derma fat transplant, or the injection of fat, from another part of the body, to enlarge the girth of the penis, followed by the incision of a suspensor ligament to increase the overall length of the penis. Such procedures run the same risks attendant to all surgical procedures, and such procedures, if effective at all, are often only temporary, thus leaving the patient after time much as he was.

One of the more popular penis enlargement techniques known is referred to as “hanging.” Hanging is probably the most used penis enlargement technique and, for length gains, is perhaps the most efficient. Significant growth results can be achieved by a properly implemented hanging regimen. This has been recognized by many, including urologists specializing in penis lengthening procedures, many of whom insist their patients hang some type of weight from their penis to improve on surgical gains and to prevent scar tissue formation. The concept of hanging is simple, namely using weights attached to a device coupled to the penis over a prolonged period of time for the purpose of stretching the penis, thus increasing its overall length. Over time, the penis is progressively stretched to achieve a permanent increase in length.

There are several types of hanging devices and/or systems in the prior art. An example is taught by Adams in U.S. Pat. No. 8,162,819. Many of these devices, such as the device of Adams, are problematic and can even be dangerous. Many of the devices used are anchored to the skin, or worse, to the glans portion of the penis which contains delicate nerve bundles. The hanging devices that are safe and provide the best results are the ones that are anchored to non-delicate structural areas of the penis shaft and progressively stretch these, as well as the ligaments and tissues present within the penis.

It would be advantageous to have a penis enlargement device that overcomes the dangers and inefficiencies of prior art hanging devices.

### SUMMARY OF THE INVENTION

The present invention, rather than hanging weight directly on the penis uses stackable weights inside enclosed plastic cylinder that slides into the device and contains the entire penis shaft of the user. The custom stackable weights create sufficient weight to collapse the neck of the device around the base of the penis, and achieved by securely connecting the flange of the device behind a custom waist strap with multiple adjustment straps to keep the device tightly pressed against user's body in groin region.

This creates the oppositional forces required to facilitate the process of stretching of the inner ligaments and inner penis tissues while keeping the entire penis shaft contact and clamps free. The concept is to minimize the surface of direct contact with the skin to the base of penis in groin region to minimize the pain discomfort of attaching the significant amounts of weights to other much more sensitive areas behind the head of penis.

Embodiments of the device include several parts. The first is a first silicone device with an avocado shaped entry flange which is inter-connected to a narrowing “hourglass” shaped ring configured to be pulled over a users penis and to securely attach onto a shaft of a penis, and to be positioned proximate at base of the penis in the groin region. The end ring is a cylinder-like arrangement that creates an oversized “bell-like” silicone touch free dome environment. The open end of the cylinder includes a number of reinforced holes to be able to attach hook ended power cords connected to ankle, knee and the foot “loop” stirrups for discrete day/night power stretching. The open end of the cylinder is also allows an insertion over a penis of an oversized hard plastic cylinder with stackable weighted mass to effectuate stretching of the penis by rotating and back in forth swinging exercises, and the like.

The second is a stealth “hourglass” ring neck also configured to be inserted onto the shaft of the penis at the base in the groin region through the avocado shaped opening of the flange. The flange is typically securely fastened to and position behind an adjustable waist strap with the entry clamping ring and the stealth “hourglass” neck-ring transforming into a volume of space cylinder. The entry ring is pulled over the head and the entire penis shaft of a user. The entry ring connects tightly at the base of the penis shaft and transition into a semi-rigid “hour-glass” shaped neck which expands into a bell like an oversized cylinder to serve as a point of entry and expands slightly excepting an oversized rigid plastic cylinder, thus creating a “no-contact” environment with the skin of the penis, thereby reducing the likelihood of pinching the skin.

The third part is an oversized rigid plastic cylinder containing a weight mass can be inserted over a penis to completely surround the entire shaft of a penis. The front edge of the weight cylinder is configured to be completely inserted inside the rest of the device to end against the inside walls of device.

### DESCRIPTION OF THE FIGURES

Several drawings are now presented to illustrate features of the present invention:

FIG. 1 shows a side view of an embodiment of the present invention.

FIG. 2 shows a back view of the embodiment of FIG. 1.

FIG. 3 shows an embodiment of a flat member with a neck in side view.

FIG. 4 shows the flat member of FIG. 3 in top view.

FIG. 5 shows an entire assembly with a waist strap.

FIG. 6 shows a plastic cylinder for use with stackable weights.

FIG. 7 shows a plastic cylinder with weights attached.

FIG. 8 show stackable weights.

FIG. 9 shows a weight container.

FIG. 10 shows a method of using the present invention with weights only.

FIG. 11 shows a method of using the present invention with cords.

Drawings and illustrations have been presented to aid in understanding the present invention. The scope of the present invention is not limited to what is shown in the figures.

### DESCRIPTION OF THE PREFERRED EMBODIMENTS

The present invention relates to a safe and efficient penis enlargement device that includes:

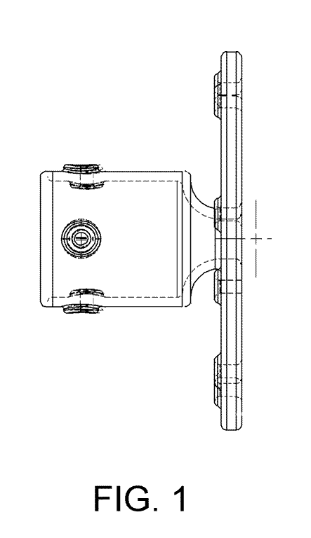

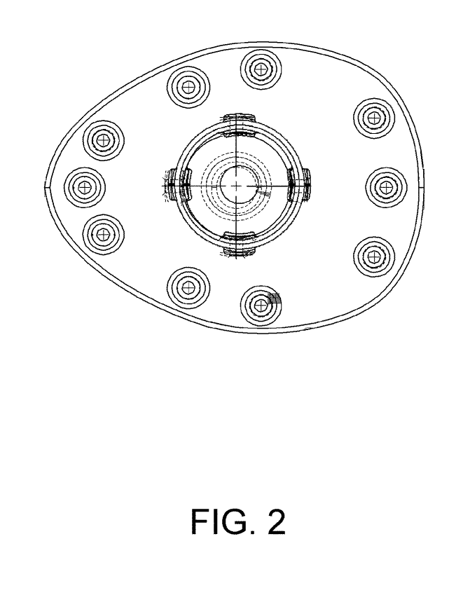

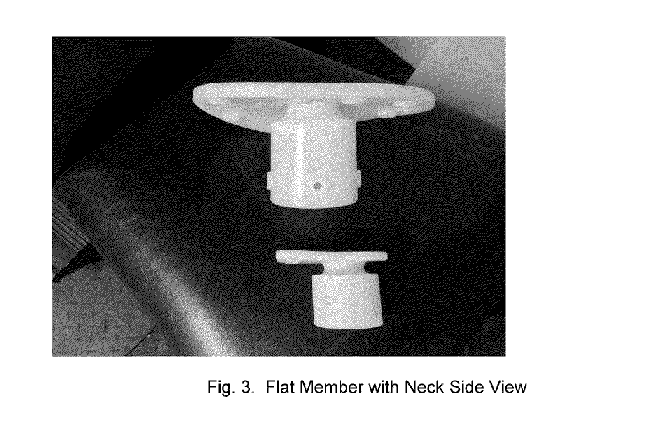

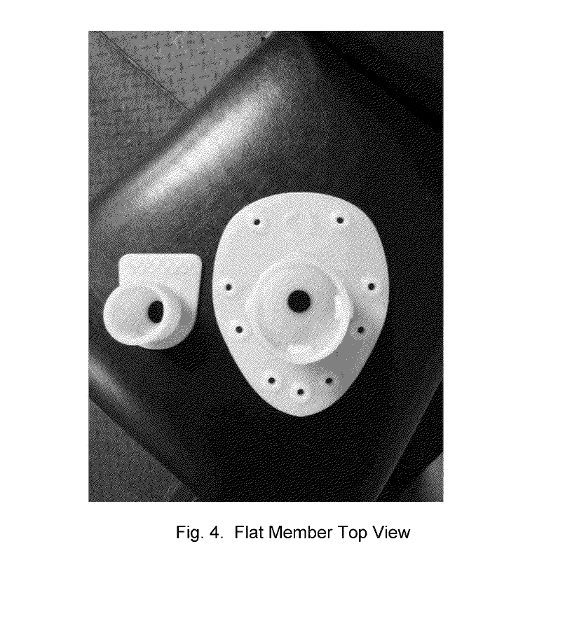

A silicone device with avocado shaped entry flange (flat member) which is inter connected to a narrowing “hourglass” shaped ring configured to be pulled over a users penis and to securely attach onto a shaft of a penis and to be positioned proximate at base of the penis in the groin region. FIGS. 1-2 show schematically an embodiment of the avocado-shaped entry flange or flat member. FIG. 3 shows a side view, while FIG. 4 shows a top view. The end ring is comprising into a cylinder to create an oversized “bell-like” silicone touch free dome environment. The open end of the cylinder features four (4) reinforced holes to be able to attach hook ended power cords connected to ankle, knee and the foot “loop” stirrups for discrete day/night power stretching. The open end of the cylinder is also allows an insertion over a penis of an oversized hard plastic cylinder with stackable weighted mass to effectuate stretching of the penis by rotating and back in forth swinging exercises and the like.

A stealth “hourglass” ring neck also configured to be inserted onto the shaft of the penis at the base in the groin region through the avocado shaped opening of the flange. The flange is to be securely fastened to and position behind an adjustable waist strap with the entry clamping ring and the stealth “hourglass” neck-ring transforming into a volume of space cylinder. The entry ring is pulled over the head and the entire penis shaft of a user. The entry ring connects tightly at the base of the penis shaft and transition into a semi-rigid “hour-glass” shaped neck which expands into a bell like an oversized cylinder to serve as a point of entry and expands slightly accepting an oversized rigid plastic cylinder, thus creating a “no-contact” environment with the skin of the penis, thereby reducing the likelihood of pinching the skin.

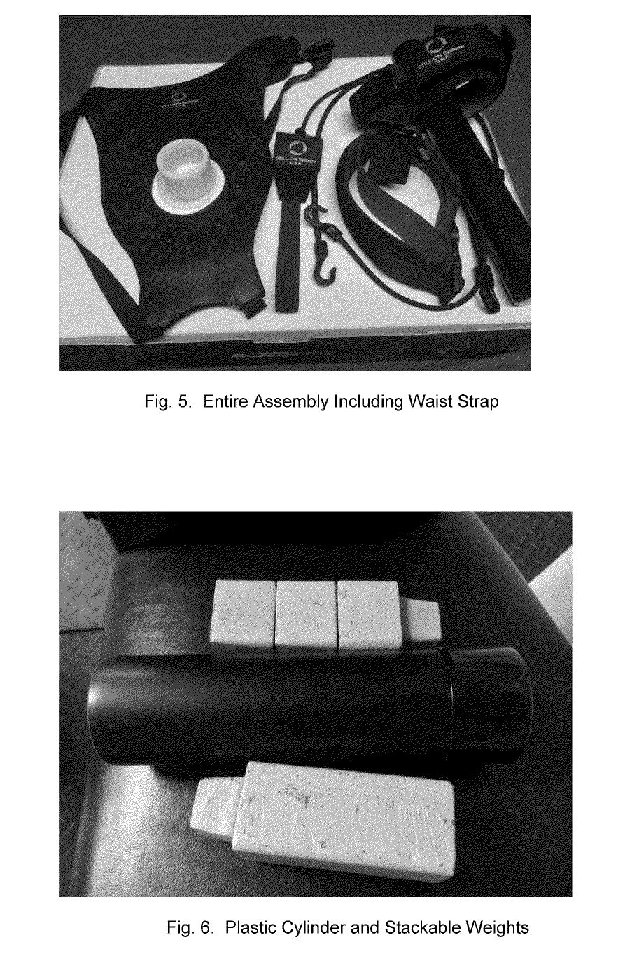

FIG. 5 shows an embodiment of the entire assembly including a waist strap.

A user beginning to use the apparatus would needs to start by stretching the entry hole of the device with two thumbs in the opposite (East-West) directions. A user than would push the entire penis through the flange entry opening. The rigid entry of the flange forms a tight contact while transitioning into the “hourglass” shaped narrowing neck expanding into an oversized dome shaped semi-rigid silicone cylinder. The flange thickness clamps in position at the base of penis and kept securely close to a user's body in the groin region by an adjustable waist strap. The inside of the outside of flange entry ring transitions into a narrowing “hourglass” shaped neck with semi-rigid walls.

The flange is securely connected behind an adjustable waist strap which keeps the ring forming entry of device at the base of a penis. When the pulling pressure is applied the “hourglass” neck stretching occurs as the opposite directional forces collapse and stretch the “hourglass” neck which was specifically designed to incorporate a strength building outer/inner wall radius which acts as the pulling source which could be described as 4 thumbs (E-W and N-S) digging into the penis stretching out the tissues and ligaments of the inner penis. When the pressure is applied and the “hourglass” neck start to collapse the radius reinforced inner walls pull-n-stretch inner tissues and ligaments of the inner penis hidden in the groin region permanently extending it and creating micro tears which are immediately healed by a human body, thus becoming permanently longer with an extra capillary capacity allowing to carry larger blood supply creating longer penis and larger girth that is pronounced and visible.

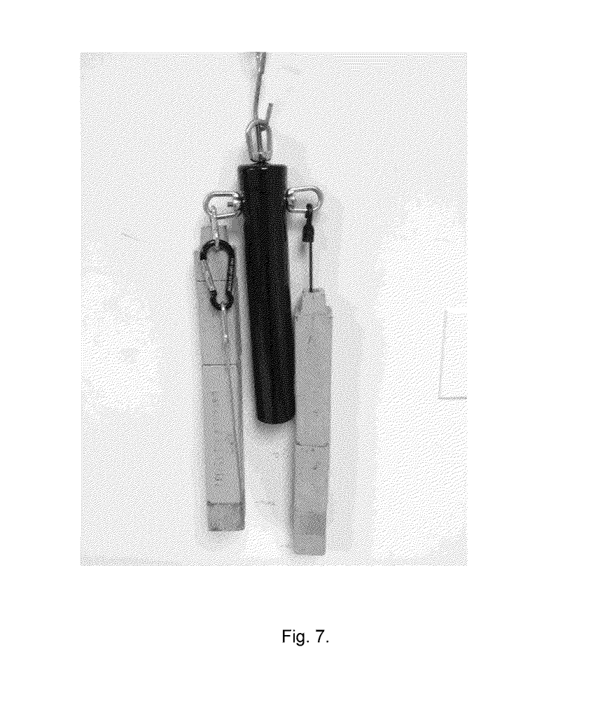

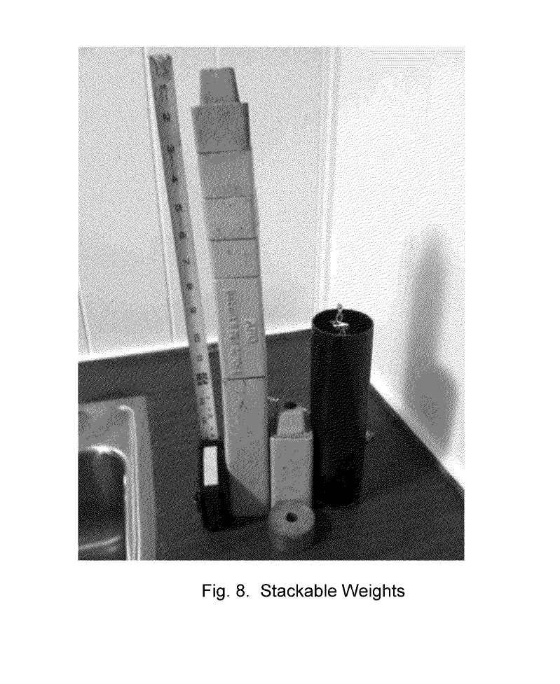

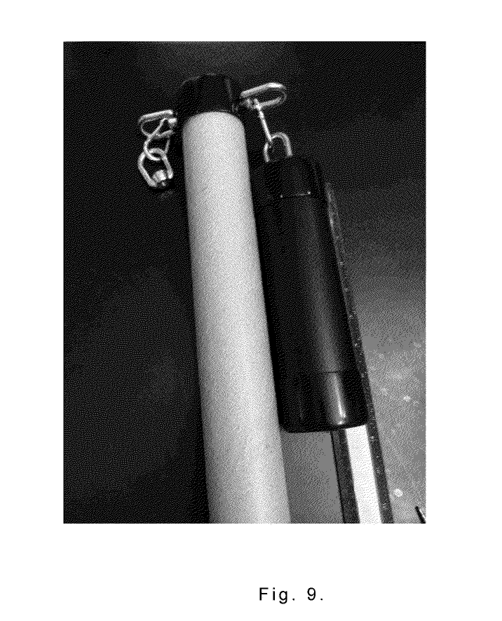

The invention can also include an oversized rigid plastic cylinder containing a weight mass designed to be inserted over a penis to completely surround the entire shaft of a penis. The front edge of the weight cylinder is configured to be completely inserted inside the device to end against the inside walls of device. The open bell like open end of device stretches to fit snug over the cylinder which is inserted all the way to fit against the inner back edge of bell like surface of the inner “hourglass” neck wall. The plastic cylinder and stackable weights are shown in FIGS. 6-7. FIG. 8 shows an embodiment of the stackable weights, while FIG. 9 shows the weight container. The plastic cylinder is very rigid and while fully inserted creates a tight fit expanding semi-rigid silicone dome further supporting it above the outside surface of weight cylinder. To insure user's safety a clamp goes over the outside of the silicone device to keep it connected to the plastic cylinder and to prevent it from slipping out. The inside diameter of weight cylinder or tube is large enough to accommodate most any size penis, thus forming essential a volume of space insuring a minimum contact with the skin well above of the shaft of the penis to reduce the likelihood of pinching, where an inner side wall extending between the front edge that butts up on the inside to the “hourglass” outer ring surface and the back edge into weight supporting rubber cap, the inner side wall having, at least in part, a nonlinear variable diameter segment, and an outer side wall extending between the front edge and the back edge; configured to stretch the penis under gravity.

One way to use the device is to insert a hook-ended power stretch cord through the D-ring of an ankle, knee or foot “loop” stirrup into the opposite directional reinforced holes (East-West) or (North-South) at the open end of the cylinder shaped end of the device creating of a bell-like, no touch environment. The hook ended tension straps can be threaded through the “D-ring” of the knee, ankle straps and foot “loops” stirrups allow various tensions and a variety of combinations of attachment to the device thus creating respectable tension required for permanent natural penis enlargements and to allow a user to continue to stretch discreetly during the day or night. A user wearing a co mbina ti on of the knee, ankle and foot stirrup with various tension straps periodically for any duration of time to effectuate enlargement of the penis is configured to facilitate its concealment when being worn. The tension power straps inserted through the D-ring of knee, ankle or foot stirrup to connect to oppose positioned (North-South, East-West) reinforced holes of the open end of the cylinder and to stretch the open “bell” forming end of the device minimizing the contact with head and shaft of penis.

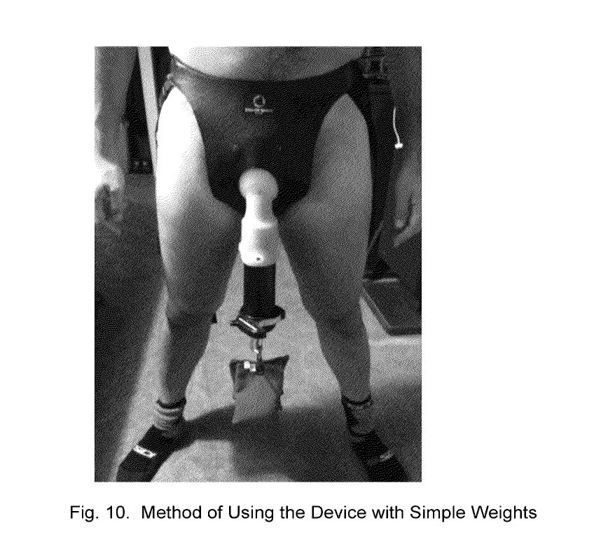

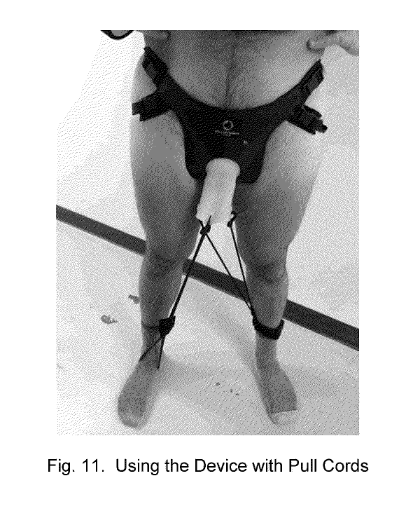

FIG. 10 shows a user wearing an embodiment of the present invention with the with simple weights while FIG. 11 shows one of the many ways the present invention can be used with pull or stretch cords. It can also be used with only one foot, or with cords to the arms, shoulders or other parts of the body or to one or more external surfaces.

### SUMMARY

The enlargement exercising stretching system is disclosed and includes as follows:

The present invention device was initially developed as a scar tissue build up preventer for post phalloplasty surgery patients whose ligaments were severed during the surgery. The present invention is very effective for post surgery patients and recreational users to be used to isolate and effectively stretch the inner penis tissues and ligaments to prevent the post surgery scar formation and proven to be very effective as an enlargement stretching exerciser device

The design and functions of the present invention device allows it to remain attached at the base of the penis in the groin region and to reach deep to the inner tissues and ligaments that are hidden inside the groin behind the pubic bone. The device securely connects to the specially designed weight strap to be securely and comfortably worn with significant weights without slippage. The device unique dual function design allows user to safely and painlessly connect the weight filled cylinder. The device also encompasses multiple connection options to securely connect the device with various tension stretch cords to knee-strap, ankle-strap and foot stirrup. The device is designed to be securely connected to a penis and withstand a significant weight tensions. The penis is inserted through the opening of the device which is securely connected to the weight strap and has just one point of contact at the base of the penis in the groin region. The entire penis is inserted through a large avocado-shaped flange and clamps by the neck of the device at the base of the penis. The entire penis is surrounded by a half hour glass “bell like” design reversed open chamber. The flange securely connected to the back of the weight strap with nine fasteners such as those called Chicago screws and tightened around the user's body. It has a function to keep the neck of the device at the base of the penis without slippage. The plastic cylinder filled with the weights is inserted into the device all a way to the end and securely clamped by specially design clamp. The waist strap pulls the flange of the device toward the user's body and the plastic cylinder containing weight mass is inserted over the entire penis inside of the device all a way to the end where a penis connects with device in the groin region pulls down. The weight cylinder could accommodate significant amount of stackable weights required to apply a stretching force onto the ligaments and tissues of the inner penis. The counter forces stretch the narrow part of the resembling the hour glass narrowing and connecting even tighter to the penis at the base preventing the slippage. The device provides the means for stretching the ligaments and tissues inside a human penis. It is quickly and easily applied to the penis and removed therefrom. The device enables further weight mass to be applied to make possible a program for stretch training of the penis through the application of incremental weight additions.

The unique design of the device allows continuous day/night medium to light stretching with power cords attached to knee straps, ankle straps and foot stirrups. The device allows its users to have a flexibility to alternate heavy weight exercises by attaching a weight cylinder with stackable heavy weights for most effective deep inner penis stretching with discrete stretching using the knee straps, ankle straps and foot stirrups for comfortable around the clock stretching.

The avocado shaped flange of the device securely and comfortably attaches behind of specially designed supporting protective weight waist strap with multiple adjustment straps to allow a user continuous stretching options if desired. The weight strap keeps the device tightly attached at the base of the user's penis in the pubic area of the groin region.

The weight cylinder designed to hold the entire penis and stackable weights. The clamp is to further secure the weight cylinder to the mouth of the device and to create a strong counter force required to isolate and to pull out the hidden inner penis located in a groin pubic area behind the pubic bone without stretching the penis outer skin.

Descriptions and illustrations have been presented to aid in understanding the present invention. One with skill in the art will realize that numerous changes and variations are possible without departing from the spirit of the invention. Each of these changes and variations is within the scope of the present invention.

We claim:

1. A penis enlargement device comprising a substantially flat member with a hole and neck adapted to fit over a human penis to be positioned flat against a user's lower abdomen; a ring member also adapted to fit around the base of the penis; a waist strap attached to said flat member adapted to hold the flat member in place; a substantially cylindrical cover attached to said neck adapted to connect to either stretch cords or to a weight container; whereby, weight or force is applied to the base of the penis causing the penis to enlarge over time.

2. The device of claim 1 wherein the weight container contains a plurality of weights configured to allow a user to choose different weight combinations.

3. The device of claim 2 wherein each of the plurality of weights is configured to be stacked.

4. The device of claim 1 wherein the flat member is avocado-shaped.

5. The device of claim 1 wherein the cylindrical cover is connected to one or more stretch cords terminating at the user's knee, ankle or foot.

6. The device of claim 1 wherein the waist strap has a flat front portion with a hole, the flat front portion being adapted to receive the flat member through the hole.

7. A device configured to enlarge a user's penis that includes a waist strap with a flat front region that holds a flat member and neck that fit around the penis, the neck attachable to a cylindrical tube that fits around and covers the penis, the cylindrical tube being attachable to weights or to stretch cords adapted to provide a downward force on the penis.

8. The device of claim 7 wherein the weights are in a weight container adapted to contain a plurality of weights.

9. The device of claim 8 wherein each of the plurality of weights is configured to be stacked.

10. The device of claim 7 wherein the flat member is avocado-shaped.

11. The device of claim 7 wherein the cylindrical tube is connected to one or more stretch cords terminating at the user's knee, ankle or foot.

12. A method of supplying a penis enlarging apparatus comprising:
supplying a substantially flat member with a hole and neck adapted to fit over a human penis to be positioned flat against a user's lower abdomen;
providing a ring member also adapted to fit around the base of the penis;
providing a waist strap attached to said flat member adapted to hold the flat member in place;
providing a substantially cylindrical cover attached to said neck adapted to connect to either stretch cords or to a weight container.

13. The method of claim 12 wherein the weights are in a weight container adapted to contain a plurality of weights.

14. The method of claim 13 wherein each of the plurality of weights is configured to be stacked.

15. The method of claim 12 wherein the flat member is avocado-shaped.

16. The device of claim 12 wherein the cylindrical cover is connected to one or more stretch cords terminating at the user's knee, ankle or foot.
